(19) United States
(12) Patent Application Publication
(10) Pub. No.: US 2014/0031123 A1
(43) Pub. Date: Jan. 30, 2014

(54) SYSTEMS FOR AND METHODS OF DETECTING AND REPRODUCING MOTIONS FOR VIDEO GAMES

(71) Applicants: Majid Sarrafzadeh, Anaheim Hills, CA (US); Hagop Hagopian, Glendale, CA (US); Jack Bobak Mortazavi, Irvine, CA (US); Jonathan F. Garcia, Lawndale, CA (US)

(72) Inventors: Majid Sarrafzadeh, Anaheim Hills, CA (US); Hagop Hagopian, Glendale, CA (US); Jack Bobak Mortazavi, Irvine, CA (US); Jonathan F. Garcia, Lawndale, CA (US)

(73) Assignee: The Regents of the University of California, Oakland, CA (US)

(21) Appl. No.: 13/980,815

(22) PCT Filed: Jan. 19, 2012
(86) PCT No.: PCT/US12/21906

§ 371 Date: Oct. 7, 2013

Related U.S. Application Data
(60) Provisional application No. 61/435,206, filed on Jan. 21, 2011.
(60) Provisional application No. 61/435,211, filed on Jan. 21, 2011.
(60) Provisional application No. 61/435,220, filed on Jan. 21, 2011.

(51) Int. Cl. A63F 13/04

(52) U.S. Cl. CPC A63F 13/04
USPC 463/36

(57) ABSTRACT

An instrument gathers and processes data from one or more capture devices. The data can thereafter be processed using one or more classification techniques to properly detect and/or reproduce motions for an application. The present invention can be used both outdoors and indoors.

### CROSS REFERENCE TO RELATED APPLICATIONS

The application claims priority of U.S. provisional application Ser. No. 61/435,206, filed Jan. 21, 2011, entitled “PROBABILISTIC ALGORITHM FOR PROPER KICK DETECTION,” of U.S. provisional application Ser. No. 61/435,211, filed Jan. 21, 2011, entitled “MOBILE FOOT-BASED GAMING SYSTEM,” and of U.S. provisional application Ser. No. 61/435,220, filed Jan. 21, 2011, entitled “METHOD FOR INTERPRETING AND REPRODUCING REALISTIC MOVEMENT AS VIDEO GAME ACTIONS,” their entirety of which is herein incorporated by reference.

### FIELD OF THE INVENTION

The present invention relates to video games. More particularly, the present invention relates to systems for and methods of detecting and reproducing motions for video games.

### BACKGROUND OF THE INVENTION

In the United States, video gaming has become a staple in many households. Reports have shown that children spend an average of as much as 44.5 hours per week playing video games. With rising concerns regarding the correlation between child obesity and the time children spend playing video games (because of the sedentary lifestyle it promotes), efforts are being made to find ways to make children more active. One approach is to find physical activities to replace video gaming, therefore attempting to limit the amount of time a child remains sedentary as a result of playing video games all day long. An alternative approach is to accept the fact that children will not give up video gaming so easily and to therefore alter the interface of video games to ensure that they have more active gaming experiences.

The Nintendo® Wii® is one of the first successful home gaming consoles to appeal to a wide range of audiences: toddlers, children, teens, young adults, adults, parents, grandparents, etc. It can be argued that the success of the Nintendo® Wii® comes from the intuitive user interface it provides and the physical activity it encourages. Traditional gaming consoles use controller devices which elude the average person, sometimes requiring complex sequences of button presses that are not only difficult to remember but also difficult to execute. Nintendo's Wiimote™ overcomes the shortcomings of such control devices by providing users a way to control video game objects and characters with intuitive motion gestures. The ability to control game objects and characters with intuitive motion gestures give users the confidence to play the game, making it a more enjoyable and satisfying experience.

The popularity of the Nintendo® Wii® gaming system and of titles such as Nintendo's WiiFIT® is evidence that there is a rising trend of gamers seeking more active gaming experiences. At its core, users interface with the gaming system through the manipulation of handheld wireless devices equipped with an accelerometer and an infrared camera. The sensed physical motion is then processed and mapped into video game controls that manipulate one or more objects or characters within the game. The handheld devices also have expansion ports to which expansion devices (e.g., an extra accelerometer, a gyroscope, etc.) can be connected to further enhance the user interface. However, these devices, because of their handheld nature, still, on the average, limit the amount of physical activity users experience while playing games, typically limiting body movement to only the upper body.

To create an even more immersive and active gaming experience, motion capture devices for gaming (including Nintendo's Wiimote™) can be used in novel ways to facilitate users in participating in full-body activities. For example, one of WiiFIT's mini-games has the user place a Wiimote™ in her pocket and jog in place. As the user jogs in place, the mini-game maps the Wiimote's movements into velocity, and the character in the game will jog at a corresponding speed. Games like this, where sensors are used to detect full-body motion, will help promote more active gaming experiences.

However, although significant work has and is being done to incorporate motion into computing activities such as video games, prior art motion capture systems such as the Wiimote™, the Wii Balance Board® and the Dance Dance Revolution® pad to name a few, are able to detect rough physical motions moving in three different directions (x, y, and z). They utilize a simple algorithm that is not adapted well to properly detect movement. Algorithmically, no work has been done to significantly clean up the signal processing.

Another shortcoming of these motion capture systems is their lack of cheating prevention. For example, Nintendo's Wii Sports™ has a tennis mini-game. The idea is to use the Wiimote™ as the user would with a tennis racquet, immersing the user in a virtual tennis experience. However, by simply flicking one's wrist while holding the Wiimote™, the user can still successfully play the tennis game. There is no requirement or focus on getting the users to swing their virtual racquets properly. The main drawback of this type of “cheating” is that users can find ways around being as active as the game was originally trying to promote.

Another shortcoming of the prior art motion capture system is that they are simply indoor devices. For example, the WiiFIT® allows users to, among other things, perform exercise routines, track their weight and body mass index. The heart of the WiiFIT® is the Wii Balance Board®. During use, a user typically positions the Wii Balance Board® in front of a television set, stands on the Wii Balance Board®, and performs exercise routines on it. The Wii Balance Board® senses weight shifts and the Wii® console determines whether the user is in a proper alignment, while results and instructions are displayed on the television set. The WiiFIT® behaves like a personal trainer, tracking the user's progress and providing feedback. However, the Wii Balance Board® must be used in conjunction with a Wii® console and a display, such as a television set. As such, the WiiFIT® remains an indoor device, preventing the user to enjoy these activities outdoors.

The present invention addresses at least these limitations in the prior art.

### SUMMARY OF THE INVENTION

Embodiments of the present invention serve as an instrument to gather and process data from one or more capture devices. The data can thereafter be processed using one or more classification techniques to properly detect and/or reproduce motions for an application, such as a game. The present invention can be used both outdoors and indoors.

In one aspect, a computer-readable medium stores instructions that, when executed by a computing device, cause the computing device to perform a method. The method includes obtaining one or more signals from at least one motion capture device. The one or more signals are obtained wirelessly from the at least one motion capture device. Alternatively, the one or more signals are obtained via a wired connection from the at least one motion capture device. The motion capture device is typically coupled a body part, such as a foot, a leg, an arm or a hand. In some embodiments, the one or more signals obtained from the at least one motion capture device are filtered.

In some embodiment, a probabilistic network, such as a Bayesian network, is used to classify a movement. First, the one or more signals are interpolated using previously collected data from a history record to thereby determine a movement class. In some embodiments, the one or more signals are interpolated by averaging a subset of values in a history record. In some embodiments, this determining step is performed by calculating a probability that the movement corresponds to that motion category based on the one or more signals and a history record for each motion category. Based on calculated probabilities, the type of the movement is determined and outputted. Alternatively, the signal information and probabilities can be given to a classifier such as a Support Network Machine for assistance. The movement class is then mapped to at least one input event recognized by a primary application. In some embodiments, the type of movement and corresponding information are stored in the history record for subsequent use.

In another aspect, a gaming kit includes at least one pad. Each pad is configured to be in contact with a foot and includes one or more sensors for capturing motion data and a transmitter for transmitting the data to a computing device, such as a mobile device. The gaming kit also includes a software application configured to be accessed by the computing device. The software application typically uses the data transmitted by the transmitter. In some embodiments, the software application is configured to retrieve information from an external source, such as the Internet and/or an external storage device coupled to the computing device.

In yet another aspect, a system maps physical motion data to an action within a primary application. The system includes a motion interpretation unit and an action mapping unit. In some embodiments, the motion interpretation unit and the action mapping unit are in communication with the primary application. The system also includes a motion sensing unit having one or more sensors.

In some embodiments, the motion interpretation unit includes a signal processor and at least one finite state machine. The signal processor is configured to encode motion data into at least one of one or more states and one or more state transitions, and to pass motion data to the action mapping unit to be directly mapped to one or more actions within the primary application. The at least one finite state machines is configured to interpret the motion data and to communicate with the action mapping unit a working knowledge of each of the at least one finite state machine. The motion interpretation unit is configured to periodically sample raw motion data from one or more motion capture devices.

In some embodiments, the action mapping unit includes an action dictionary configured to map at least one of one or more states and one or more state transitions to one or more input events recognized by the primary application. In some embodiments, the action mapping unit is at least partly integrated with the primary application.

### BRIEF DESCRIPTION OF THE DRAWINGS

Reference will now be made in detail to implementations of the present invention as illustrated in the accompanying drawings. The same reference indicators will be used throughout the drawings and the following detailed description to refer to the same or like parts.

FIGS. 1A-C illustrate exemplary capture devices in accordance with the present invention.

FIGS. 2A-2B illustrate exemplary networked computing devices in accordance with the present invention.

FIG. 3 illustrates a system for detecting and reproducing motions in accordance with the present invention.

FIG. 4A illustrates a flowchart of the probabilistic algorithm in accordance with the present invention.

FIG. 4B illustrates a capture device strapped to a foot in accordance with the present invention.

FIG. 4C illustrates details of the steps 420 and 425 of the flowchart 400 of FIG. 4A in accordance with the present invention.

FIGS. 5A-5B illustrate exemplary diagrams of capturing and interpreting physical motions and reproducing them as video game actions in accordance with the present invention.

FIG. 6A illustrates an interpretation and reproduction of a video game “jump” action in accordance with the present invention.

FIGS. 6B-6C illustrate two exemplary state machines to interpret jump motions in accordance with the present invention.

### DETAILED DESCRIPTION OF THE INVENTION

In the following description, numerous details are set forth for purposes of explanation. However, one of ordinary skill in the art will realize that the invention may be practiced without the use of these specific details. Thus, the present invention is not intended to be limited to the embodiments shown but is to be accorded the widest scope consistent with the principles and features described herein.

Embodiments of the present invention serve as an instrument to gather and process data from one or more capture devices. The data can thereafter be processed using one or more classification techniques to properly detect and/or reproduce motions for an application, such as a game. The present invention can be used both outdoors and indoors.

### Exemplary Systems and Components Therein

A capture device of the present invention typically includes one or more sensors. The one or more sensors include accelerometers, gyroscopes, ECG, magnetometer, and/or the like. The sensors typically detect external conditions such as acceleration (linear and angular), velocity (linear and angular), pressure, EMG and other relevant data. The capture device also includes other components, such as a controller, a processor and a transmitter, which are coupled to the sensors, for gathering, processing and transmitting the data detected by the sensors. Data is typically transmitted to at least one networked computing device. In some embodiments, data is wirelessly transmitted to the computing device via a personal area network using technology such as Bluetooth, ZigBee or the like, or via a larger network. Alternatively, or in addition, the data is transmitted to the computing device via a wired connection.

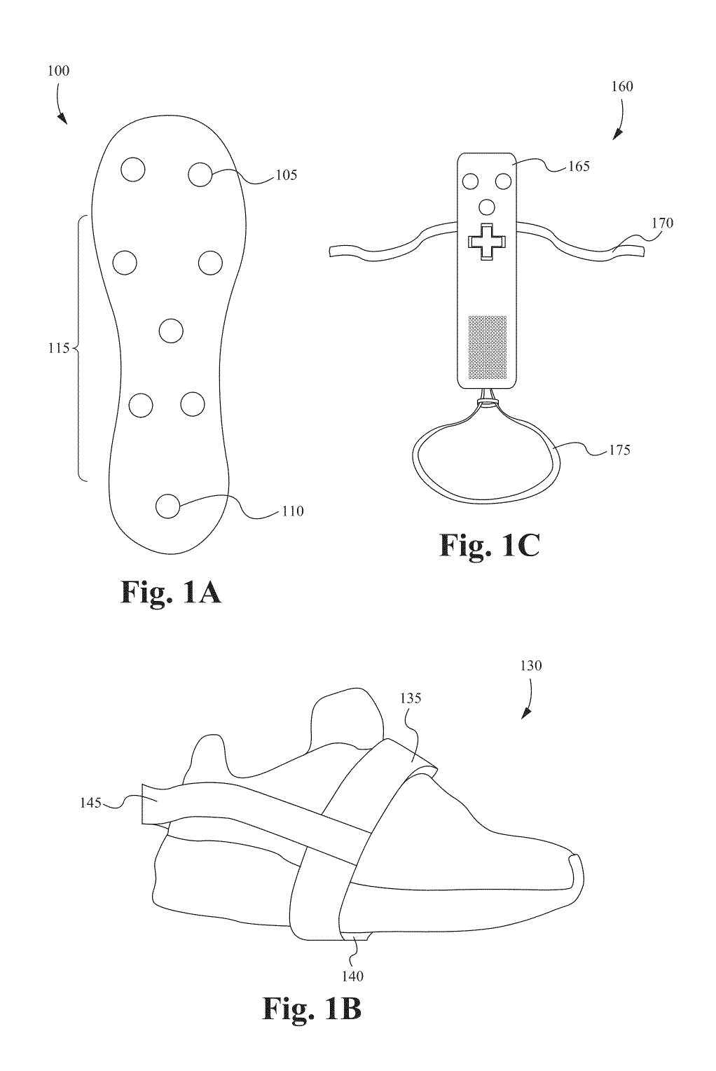

In some embodiments, a capture device is in the form of a pad. FIG. 1A illustrates an exemplary pad in accordance with the present invention. The pad 100 is configured to be placed inside a shoe or a sock such that the pad 100 can be in indirect or direct contact with a user's foot. The pad 100 typically includes one or more sensors. In some embodiments, a first sensor 105 is located approximately at a toe area of the pad 100 and is in contact with a user's toes when in use, and a second sensor 110 is located approximately at a heel area of the pad 100 and is in contact with the user's heel when in use. The pad 100 can include additional sensors 115 that are positioned, for example, between the first sensor 105 and the second sensor 110. FIG. 1A shows additional sensors 115 along right, left and arch areas. Placement of the sensors 1005, 110, 115 can be random, pseudo-random or strategic. In some embodiments, the one or more sensors are pressure sensors.

In some embodiments, a capture device is the form of a harness. FIG. 1B illustrates an exemplary harness in accordance with the present invention. The harness 130 can be strapped around a foot, a leg, a hand, an arm, or other suitable body parts. In FIG. 1B, the harness 130 is shown as being strapped around a shoe using one or more straps 145. The harness 130 typically includes one or more sensors. In some embodiments, a first sensor 135 is located at a top of the harness 130. The first sensor 135 includes a 3-axis accelerometer. For example, when the harness 130 is worn around a foot, the x-axis runs along a diagonal axis down the slope of the foot, the z-axis runs perpendicular to left and right planes of the foot, and the y-axis runs perpendicular to the other two. Other axis definitions are possible. In some embodiments, the harness 130 further includes a second sensor 140 located at a bottom of the harness 130. The second sensor 140 can be a pressure sensor. The pressure sensor 140, based upon whether it should be reading pressure or no pressure, can help determine if any movement is occurring.

In some embodiments, a capture device is in the form of a wand. FIG. 1C illustrates an exemplary wand in accordance with the present invention. The wand 160 includes a casing 165 that houses one or more sensors. In some embodiments, a first sensor includes a 3-axis accelerometer. In some embodiments, the wand 165 can also include an optical sensor. The wand 160 can include an adjustable strap 170 and/or an adjustable strap 175 so that the wand 160 can be worn by or strapped to a user. Alternatively, the wand 160 can simply be placed in a pocket when in use.

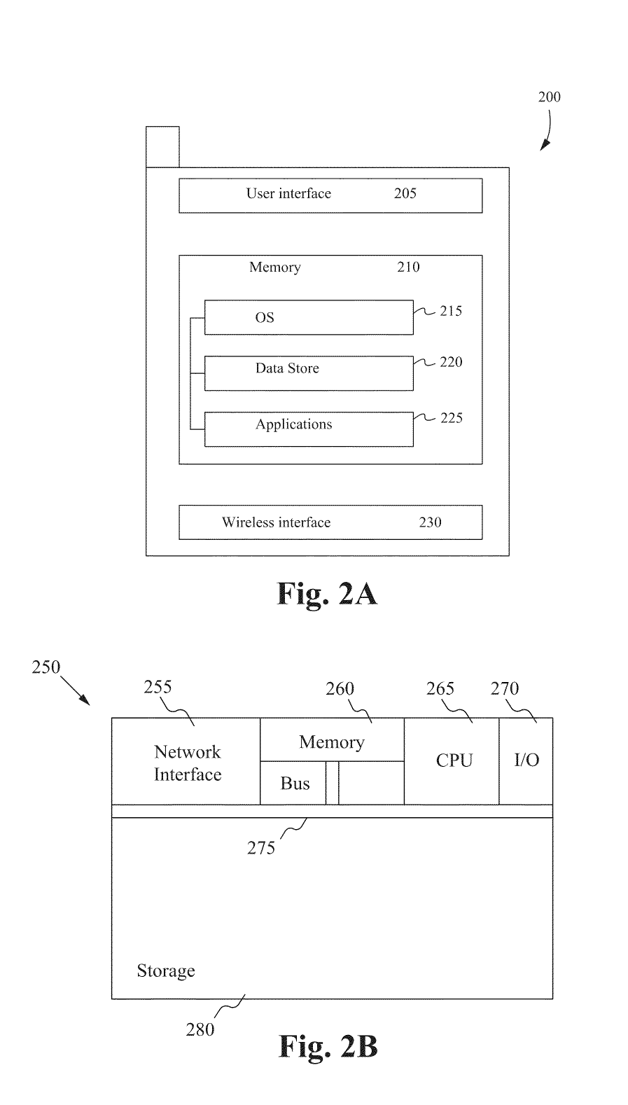

A networked computing device communicatively coupled with one or more capture devices can be mobile or stationary. FIG. 2A illustrates a graphical representation of an exemplary mobile device in accordance with the present invention. In general, a hardware structure suitable for implementing the mobile device 200 includes system memory 210 which may further include an operating system (OS) 215 having operating system services including telephony and linking services, networking services, multimedia and graphics display services all provided to a user interface (UI) 205. The OS 215 can be the mobile device's proprietary OS, BREW, or any other operating system suitable for a mobile device. The mobile device 200 preferably includes a native data store 220 which contains information which may be provided by a user. Applications 225 are loaded into the mobile device 200. Applications can be provided by a device manufacturer and/or downloaded by a user at a later time. The mobile device 200 further includes one or more wireless interfaces 230 for communicating with other devices in WPANs (wireless personal area networks), WLANs (wireless local area networks), WMANs (wireless metropolitan area networks) and/or WWANs (wireless wide area networks). The mobile device of the present invention can be a smart phone, a personal digital assistant, a tablet computer, or a special purpose mobile device.

FIG. 2B illustrates a graphical representation of an exemplary stationary device 250 in accordance with the present invention. In general, a hardware structure suitable for implementing the stationary device 250 preferably includes a network interface 255, a memory 260, processor 265, I/O device(s) 270, a bus 275 and a storage device 280. The choice of processor is not critical as long as the processor 265 has sufficient speed. The memory 260 is preferably any conventional computer memory known in the art. The storage device 280 can be a hard drive, CDROM, CDRW, DVD, DVDRW, flash memory card or any other storage device. The stationary device is able to include one or more network interfaces 255. An example of a network interface includes a network card connected to an Ethernet or other type of networks such as those discussed above. The I/O device(s) 270 are able to include one or more of the following: keyboard, mouse, monitor, display, printer, modem and other devices. Applications are likely to be stored in the storage device 280 and memory 260 and are executed by the processor 265. The stationary device of the present invention can be a desktop computer or a laptop computer. The stationary device of the present invention can also be a gaming console coupled to a television screen or a computer screen.

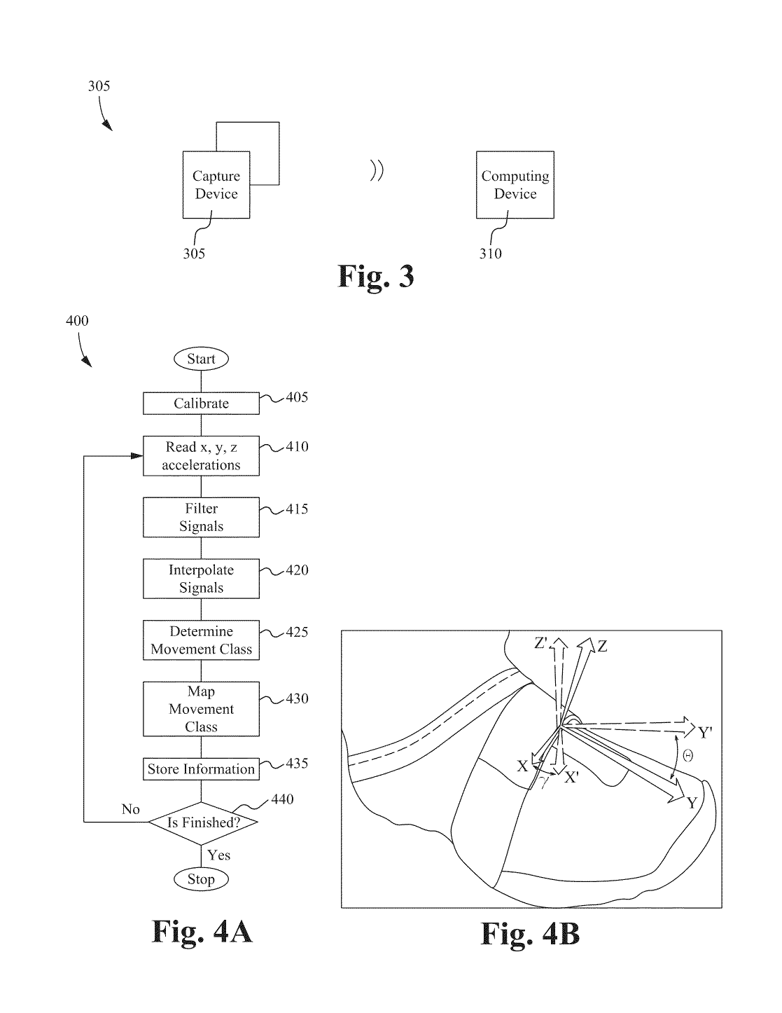

FIG. 3 illustrates a system for detecting and reproducing motions in accordance the present invention. The system 300 can include one or more capture devices 305 and one or more computing devices 310. In FIG. 3, a plurality of capture devices 305 is shown as being communicatively coupled with one computing device 310. The computing device 310 typically executes at least one application (hereafter “primary application”) that uses data received from the one or more capture devices 305 to interact with and/or present information to the user. In some embodiments, the principal application is able to access information from an external source, such as from the Internet or from a coupled storage device, to enhance user experience. The principal application typically includes the logic of the application.

In some embodiments, a package is sold to users which includes at least one capture device, such as the pad 100 illustrated in FIG. 1A, and a principal application. The principal application can be accessed onto a computing device, such as the mobile device 200 illustrated in FIG. 2A. In some embodiment, the principal application can be installed from a source. For example, a pedometer application can be downloaded and installed onto a computing device. The pedometer application is able to utilize data wirelessly received from the pad 100 to monitor the user's movement behavior and/or suggest fitness routines.

To properly detect, interpret and/or reproduce a physical motion, the present invention uses a probabilistic algorithm, finite state machines or both to accurately, and even realistically, recognize motions. These classification techniques can be implemented in an application or a script (hereafter “secondary application”) that is completely or partly integrated with the primary application, or can be completely separate from the primary application. The secondary application containing one or more techniques is executed alongside the primary application. The secondary application can be executed on the same or different computing device as the one that primary application is executed on. Each of these techniques is discussed in detail below.

### 1. Using Probabilistic Algorithm for Proper Detection of Specific Physical Motion

This technique of the present invention uses basic tools and information for processing signals and input the information to the logic of a primary application. This technique uses Bayesian probabilities networks and/or other statistical algorithms (e.g., Support Vector Machines) to accurately classify specific physical motions or other detectable activities of the body, such as punches, kicks, head-butts, etc. The detection of these activities can be done through the use of one or more sensors that detect characteristics of these activities such as acceleration, velocity, pressure and EMG.

For example, the algorithm for this technique uses motions that are mapped and implemented to properly control movement of a soccer player in a soccer game. Motions in the soccer game include, but are not limited to, a sideways passing movement, a forward kicking/shooting movement, an upward running movement. While the invention described hereafter in this section is relative to a soccer game, the invention can be applied to other types of games.

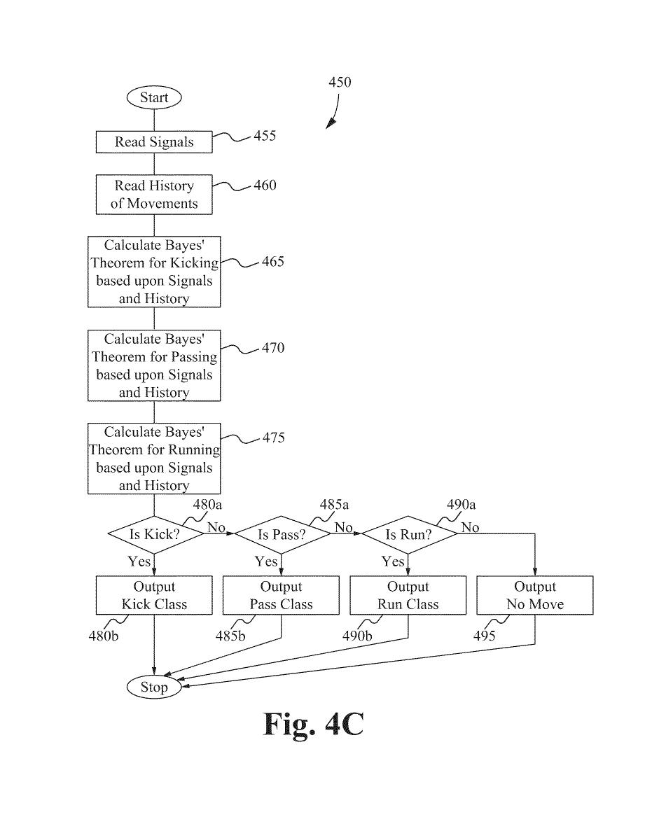

FIG. 4A illustrates a flowchart of the probabilistic algorithm in accordance with the present invention. The probabilistic algorithm receives input from sensor(s), views past history, and references a probabilistic network to determine what action is being taken. The flowchart 400 begins at a step 405. At the step 405, at least one sensor of a capture device, such as the capture device 130 illustrated in FIG. 1B, is calibrated.

In some embodiments, calibration is done by first positioning the capture device 130 flat on, for example, a table. By knowing values of acceleration on the accelerometer 135 based upon reading the data when the capture device 130 is laid flat, an ideal configuration for the capture device 130 is known. In this position, a first axis (e.g., Y-axis) moves forward and back, a second axis (e.g., X-axis) moves side to side, and a third axis (e.g., Z axis) moves up and down. Since the raw values are known, the capture device 130 is instantly calibrated when the capture device 130 is switched on.

Based upon the initial reading of the capture device 130, as the user activates the accelerometer 135, a rotation matrix is applied to the values of acceleration. The rotation matrix is based upon the angle of inclination downward between the three point vector formed by the initial x, y, z accelerometer values and the currently read x, y, z values. For example, assume that the capture device 130 is strapped to the foot, as illustrated in FIG. 4B, and the rotation along the Z-axis is restricted. An x′, y′, z′ vector and two rotation angles around the Y- and X-axes are generated. Rotation based upon an angle is calculated using the following equation:

$$cos ( θ ) = \frac{\vec{v} 1 \cdot \vec{v} 1}{‖ \vec{v} 1 ‖ ‖ \vec{v} 2 ‖}$$

After obtaining the rotation, the rotation matrix is calculated. Any new reading of the accelerometer 135 is multiplied by the rotation matrix, causing a calibrated value, that accounts for the effects of gravity, without needing the user to actively participate in any calibration phase or do any special movements as this is done at the beginning of the algorithm when the capture device 130 is first turned on.

At a step 410, values are read from the accelerometer 135 to determine the direction of motion. This can be done via a wireless connection, a wired connection or by any other methods known to those of ordinary skill in the art. In some embodiments, this is done through a polling method using the Zigbee protocol. Preferably, the accelerometer 135 can be read at a frequency as high as 100 Hz or as low as 20 Hz through frequencies outside this range is contemplated. The reading of the accelerometer 135 is multiplied by the rotation matrix.

The value of the pressure sensor 140 can also be read. Based upon whether the value of the pressure sensor 140 should be read, it can help determine if a movement is occurring or not. The pressure sensor 140 is typically located at the bottom of the capture device 130. When the capture device 130 is worn around a foot, the pressure sensor 140 is located beneath the foot. In some embodiments, the pressure sensor 140 helps filter noise from accelerometer vibrations when steps are taken to determine if kicks and passes are occurring or if the user is simply running. If the pressure sensor 140 senses weight of the user, then the foot is likely not in the air moving for a kick or a pass, and the user is likely to be standing. The use of pressure sensor 140 can prevent false positives from accelerometer vibrations and can prevent cheating by ensuring that the user is indeed standing. By applying pressure and releasing it for durations of time, the rate at which the feet, for example, are running can be measured, and can be used to verify kicks are actually happening when the foot is in the air.

At a step 415, the signals read from the accelerometer 135 are filtered. This filtering reduces noise and gives a more accurate value representing the movement. This filtering also puts the values into a range that the rest of the probabilistic algorithm can work with. In some embodiments, the filtering is done on each axis independently by normalizing values to 0. The normalization allows positive to be forward movements for shots, left movements for passing (the idealized pass movement for a right-footed player) and upward for running. It should be understood that bigger and smaller ranges of movements are possible, depending on the filtering method used. Other normalizing methods are possible from using the absolute values to more complicated filtering (such as low-pass, high-pass, band-pass etc.) to remove noise and then normalize values.

At a step 420, values from the current reading are interpolated to further remove noise or determine a change in direction. Since any one reading may be erroneous for a number of reasons, the probabilistic algorithm interpolates values from previous history in order to more accurately determine what is happening. In some embodiments, the last three values are averaged to better adjust the value. This both corrects noise but makes changes more gradual by forcing the player to actively move in greater motions to prevent cheating or small waggle problems. Interpolation can be done in a more complicated fashion, weighing certain historical values versus the current reading differently, or taking a greater history of values, or smaller, and using these numbers as desired.

After interpolating the values determined, at a step 425, a movement class is determined based on the interpolated signals. A simple method would be to use threshold testing, but this does not lend itself to accurate movements and often can cause false positives. If thresholds are too low, running, kicking, and passing motions cannot be accurately distinguished. If thresholds are too high, a movement may not be detected because it is simply confused with noisy behavior. As a result, a probabilistic method is needed in order to more accurately and properly determine what is moving and in what fashion. This also resolves confusing scenarios when information from the accelerometer 135 is noisy and does not properly attribute to, for example, a perfect kick or perfect pass. As such, a history of values is read to calculate probabilities to determine a movement class.

A probabilistic method will allow the algorithm to learn the proper behavior and use past values and tests to determine if scenarios that are unfolding are more likely to be motion A or motion B. In other words, if one were to swing their leg forward and slightly to the left, the probabilistic algorithm is able to determine and learn from past behavior whether a kick was actually intended or if the kick should have been interpreted as a pass instead. The probabilistic algorithm is able to learn from a test set and store its results to use in later comparisons and predict what movements are happening, in order to better reduce false positives and accurately determine movement types and strengths.

FIG. 4C illustrates details of the steps 420 and 425 of the flowchart 400. Specifically, it shows the use of Bayes' Theorem to determine movements after reading the values and reading the history of the values probabilities. By using Bayes' theory of conditional probability, where two events A and B can occur, the probability that A occurs given B has occurred, or P(A|B), is equal to the probability that B occurs given A has happened, times the probability that event A occurs independently, divided by the probability that even B occurs independently. In other words, for example, the probability a kick occurs given the last set of accelerations tended towards a kick versus a pass will be higher than a pass in that situation. Based on the probability, the algorithm is able to better predict that a kick is happening.

When training and building the probabilities for the Bayesian Network, false positives are identified and probabilities of events adjusted so that the algorithm learns and becomes stronger over time. Because of this, later comparisons will be able to better predict what movements are actually occurring, and thus will reduce false positives, and may even serve to accurately determine total applied strength and speed of the motion itself.

Referring to FIG. 4C, the method 450 begins at a step 455, where filtered signals are read. At a step 460, the history of movements is read. As discussed above, the history will help determine if scenarios that are unfolding are more likely to be motion A or motion B. At the steps 465-475, Bayes' Theorem for kicking, passing and running are calculated based on the signals and history. The steps 465-475 can be performed concurrently or in a different sequence than that illustrated in FIG. 4C, as long as Bayes' Theorem for kicking, passing and running are calculated.

At a step 480a, it is determined whether the movement is a kick. If the movement is a kick, a kick class is outputted at a step 480b, and the method 450 ends. If the movement is not a kick, at a step 485a, it is determined whether the movement is a pass. If the movement is a pass, a pass class is outputted at a step 485b, and the method 450 ends. If the movement is not a pass, at a step 490a, it is determined whether the movement is a run. If the movement is a run, a run class is outputted at a step 490b, and the method 450 ends. If the movement is not a run, then a no move is outputted at a step 495, and the method 450 ends. The determination steps 480a-490a do not necessarily need to follow the sequence illustrated in FIG. 4C. Further, it should be understood that the multi-class classifications need not be limited to kick, pass and run, as discussed. Other movements, including throw, punch, jump, etc., can also be classified.

Other probabilistic and statistical methods can fall in this category as well and the algorithm will still work the same, since values are turned into classifications for movements and length of these movements. For example, in place of a Bayesian Network, one could use Support Vector Machines, that, instead of learning and adjusting probabilities while running, learn by taking a larger set and attempt to find the subset that more properly predicts movements is found to build the probabilities that the algorithm will then use to determine if test actions later are certain movements or not, for example, running, shooting, or passing. It is therefore contemplated that such classifications can be attained by, for example, calculating probabilities, applying Support Vector Machines for classification based on the calculated probabilities, signals, and history, and then outputting a movement class.

Referring back to FIG. 4A, once a proper movement is determined at the step 425, the movement class is mapped to whatever output needs to sense the movement at a step 430. Specifically, the probabilities in the previous set output a classification for the move that the algorithm then can move on to whatever device that needs the movement. For example, the algorithm classifies soccer movements (e.g., shooting, running, and passing) and generates these movements to be passed to the logic (e.g., game logic) of the primary application, or generates a continuation of movements if the new values from the sensors indicate that such a move is still occurring, thus allowing for stronger kicks versus weaker, and faster running movement versus slower.

At a step 435, these set of values and actions are stored as another stage to then be used in further interpolation and predictions in the next iteration of the algorithm. This storage can be done in any fashion as necessary based upon how the interpolation and probabilities are done as mentioned earlier.

The algorithm loops and repeats as necessary until it is determined at a step 440 that the actions are no longer needed to be viewed and the user stops the algorithm.

### 2. Using a Finite State Machine for Interpreting and Reproducing Realistic Movements

This technique of the present invention uses one or more finite state machines (FSMs) for interpreting and reproducing realistic motion as video game actions. FSMs can control the behavior of a primary application by defining a finite set of application states, state transitions and actions. State diagrams provide easy to understand illustrations of such state machines, making it easy to communicate the logic flow of the primary application. FSMs are suitable for motion interpretation because they are deterministic, have low computational overhead, and allow signals to be described and analyzed within some context (as defined by the state machine). The low computational overhead of FSMs make them perfect candidates for video game applications and other applications that require real-time response to user input. By using finite state machines to interpret and reproduce realistic motion captured from body-wearable sensors as video game actions, gamers can be put into more immersive and active gaming experiences The advantages of using FSMs for interpreting and reproducing motion is that they are deterministic, they are easy to construct, and they have low computational overhead.

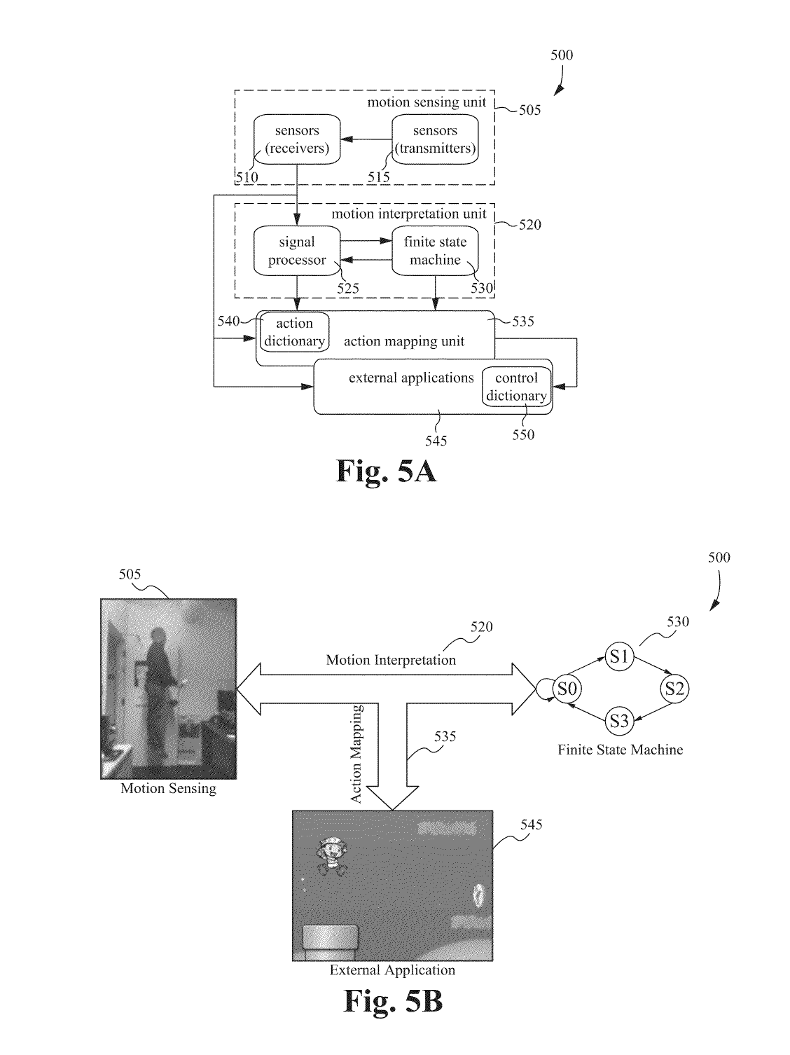

FIGS. 5A-5B illustrate exemplary diagrams of capturing and interpreting physical motions and reproducing them as video game actions in accordance with the present invention. At a high level, a user provides motion data using one or more capture devices 505, which is then interpreted 520 with one or more finite state machines 530, which is finally mapped 535 into an action within a primary application 545.

Specifically, the motion sensing unit 505 includes sensors 510, 515 of one or more capture devices for transmitting and receiving motion data. Physical motion data is captured by one or more sensors 515, which includes, but not limited to, an accelerometer, a gyroscope, a camera, an illuminated array, and/or an RF tag. Motion data is received by one or more sensors 510, which transfer the motion data to the motion interpretation unit 520. The data transfer can be done via direct wired connection, wireless data transmission or by any other methods known to those of ordinary skill in the art.

Raw motion data is periodically sampled from one or more motion sensors of the motion sensing unit 505. A signal processing unit 525 encodes the processed motion data using one or more states and/or one or more state transitions 530, or it passes the processed motion data directly to the action mapping unit 535 to be directly mapped to one or more actions within the primary application 545.

One or more finite state machines 530 are constructed from the identified states and state transitions and are used for interpreting the physical motion (using the received motion data). These finite state machines 530 preferably provide short term memory, providing signals a context at the particular time that it is sampled. This short term memory allows for a more reliably interpreted physical movement because certain motions can have different effects depending on the users previous state.

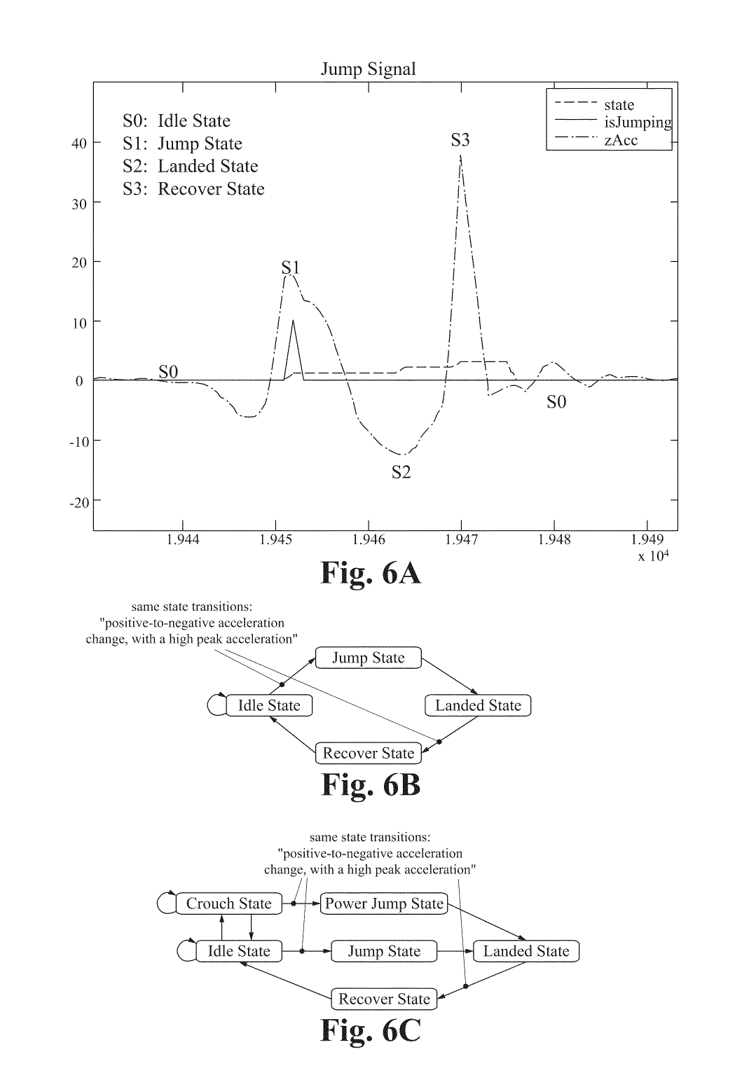

For example, FIG. 6A illustrates an interpretation and reproduction of a video game “jump” action. Because the motion data from jumping and from recovering look very similar, four-state finite state machine can be used to place that motion data into the correct context. As such, motions that look almost identical when sampling the signal instantaneously can be properly interpreted.

Continuing with the example, FIGS. 6B-6C illustrate two exemplary state machines to interpret jump motions in accordance with the present invention. Since a finite state machine is used, a JUMP STATE can be distinguished from a RECOVER STATE (as shown in FIG. 6B), and a JUMP STATE can be further distinguished from a POWER JUMP STATE (as shown in FIG. 6C). When analyzing signals instantaneously at regularly sampled intervals, the signals look very similar, and can therefore be mistakenly interpreted as the same motion. It is the short term memory that the finite state machine is able to make a distinction between the two.

Referring back to FIGS. 5A-5B, the action mapping unit 535 receives as input a stream of raw motion data from the motion sensing unit 520, processed motion data from the motion interpretation unit 520, and a working knowledge of each finite state machine 530 within the motion interpretation unit 520. The action mapping unit 535 typically includes an action dictionary 540 that maps one or more states and/or one or more state transitions to one or more input events recognized by the primary application 545.

The primary application 545 typically contains one or more virtual objects or characters that are to be controlled. The primary application 545 can include a control dictionary 550 that maps one or more input (e.g., mouse, keyboard, joystick, gamepad, etc.) events to one or more actions defined by the primary application 545; for example, the right button on the keyboard may map to the “walk right” action, etc. In some embodiments, the action mapping unit 535 is completely or partly integrated with the primary application 545, or it can be completely separate from the primary application 545.

Using motion data from sensor(s) of one or more body-wearable capture devices, such as those illustrated in FIGS. 1A-1C, the user's motion is processed in the motion interpretation unit 520. The interpreted motion can either be fed directly into the action mapping unit 535 or into one of the finite state machines 530. The finite state machines 530 can have one or more entry actions, exit actions, input actions, or transition actions defined which directly map to the primary application's (e.g., a video game) 545 controls.

Exemplary Implementation.

As a proof-of-concept, this system was tested and implemented using two Nintendo Wiimotes as the capture devices in the motion sensing unit, GlovePIE was used as both the motion interpretation unit and action mapping unit, and the game “Super Maryo Chronicles” was used as the primary application.

Nintendo's Wiimotes have a built-in 3-axis accelerometer from which the raw motion data was captured. Theses devices used the bluetooth protocol to pair with a machine running Windows XP. The setup for the interface for this particular application required one Wiimote™ to be held by the user, while another Wiimote™ to be placed in a pant pocket of the user (or somehow otherwise attached to align with one of the user's thighs).

The Wiimote™ that is held senses two motions: a throwing motion and a twisting motion. The throwing motion maps to the game's throw fireball action, and the twisting motion maps to the games enter door action (the twisting is supposed to correspond to the motion of twisting a doorknob to open a door). The Wiimote™ that is aligned with the user's thigh also senses two motions: a jumping motion and a squatting/kneeling motion. The jumping motion maps to the game's jump action, and the squatting/kneeling motion maps to the game's crouching/ducking action.

Although this implementation has the ability to sense four different motions performed by the user, only the interpreting of the jumping motion makes use of a finite state machine. This is because the other three motions' raw data were enough to be able to interpret whether or not those motions were being performed. The jumping motion, on the other hand, required more information in order to be interpreted correctly.

To understand the mechanics of a jump motion, it is helpful to visualize the signal of the z-acceleration. As seen in FIG. 6A, the z-acceleration during a jump comprises of two troughs and two peaks. First, a trough is encountered. This trough corresponds to the user building up energy by slightly bending her legs. Going from the stationary position (e.g., standing straight up) to bending of the legs causes a negative acceleration, which leads into the first trough. Next, a peak is encountered. This first peak corresponds to the actual jumping motion of the user and is illustrated by a positive z-acceleration. Once the user reaches the peak of her jump, gravity takes over and brings her back down to the ground. This is illustrated by negative z-acceleration that leads into the second trough. Finally, after the user lands, the user must recover. Typically when a person lands from a jump, the knees bend upon impact to distribute the force evenly. The recovery happens when the user stands back upright, which is indicated by the positive acceleration that leads into the second peak. The signal indicates that as the user stabilizes from the jump, the z-acceleration hovers around zero.

In preliminary tests for interpreting jump motions, simple thresholding was used to detect jumps. That is, if the z-acceleration crossed a certain threshold, a jump was interpreted. This initial implementation, however, lead to many false positives (e.g., jump actions being registered when the user did not jump). To overcome these false positives, the mechanics of a jump and how each sub-motion (e.g., energy build-up, the actual jump, landing, and recovering) is represented by the motion data must be understood. The challenge was that the jump sub-motion looks very similar to the recover sub-motion when sampling the signal instantaneously. From this, creating a finite state machine to give the signal context in order to properly interpret the motion became clear.

The finite state machine can inherently provide short-term memory, so to speak, which is useful in determining whether the sampled signal is a jump motion or a recover motion. If the user was in an idle state, and then a positive z-acceleration is encountered that crosses some threshold, the FSM can correctly interpret that as a jump motion. If, however, the user just landed and then a positive z-acceleration is encountered, the FSM can interpret that as a recover motion, and not signal a jump. The state machine implemented for this particular application is illustrated in FIG. 6B.

GlovePIE was used to define and implement the finite state machine. GlovePIE is an open-source solution for emulating joystick, keyboard, and mouse input using other external devices, such as Nintendo's Wiimotes. The way it works is that the developer writes a GlovePIE script that processes the signals from the external devices and creates the desired keyboard, mouse, and joystick mappings. Once the script is ready to go, it is executed alongside the application which will use these new input mappings. For example, for this application, the JUMP STATE is mapped to the keyboard button “S,” which in the game is the JUMP BUTTON.

“Secret Maryo Chronicles” is an open-source, 2D sidescrolling action game that is very similar to Nintendo's Super Maryo Brothers. Side-scrollers are essentially made up of many 2D virtual obstacle courses (e.g., levels), and the objective of the game is to reach the end of each level without dying. Each level is littered with enemies and traps that try to impede the user's progress. This game was chosen because of the amount of jumping involved. By making the user jump in order to make the Maryo character jump, it is hoped that a very active (and enjoyable) gaming experience was achieved.

While the invention has been described with reference to numerous specific details, one of ordinary skill in the art will recognize that the invention can be embodied in other specific forms without departing from the spirit of the invention. Thus, one of ordinary skill in the art will understand that the invention is not to be limited by the foregoing illustrative details, but rather is to be defined by the appended claims.

We claim:

1. A computer-readable medium storing instructions that, when executed by a computing device, cause the computing device to perform a method comprising:
a. obtaining one or more signals from at least one motion capture device; and
b. using a classification technique to classify a movement.

2. The computer-readable medium of claim 1, wherein the motion capture device is coupled a body part.

3. The computer-readable medium of claim 1, wherein the one or more signals are obtained wirelessly from the at least one motion capture device.

4. The computer-readable medium of claim 1, wherein the method further includes filtering the one or more signals obtained from the at least one motion capture device.

5. The computer-readable medium of claim 1, wherein the using classification technique includes:
a. interpolating the one or more signals using previously collected data from a history record to thereby determine a movement class; and
b. mapping the movement to at least one input event recognized by a primary application.

6. The computer-readable medium of claim 5, wherein the interpolating the one or more signals includes averaging a subset of values in a history record.

7. The computer-readable medium of claim 5, wherein the mapping the movement includes:
a. for each motion category, calculating a probability that the movement corresponds to that motion category based on the one or more signals and a history record;
b. based on calculated probabilities, determining a type of the movement; and
c. outputting the type of movement.

8. The computer-readable medium of claim 7, wherein the method further comprises storing the type of movement and corresponding information in the history record.

9. The computer-readable medium of claim 1, wherein the classification technique is one of a probabilistic network and a deterministic method.

10. A gaming kit comprising:
a. at least one pad, each configured to be in contact with a foot, includes:
1. one or more sensors for capturing motion data; and
2. a transmitter for transmitting the data to a computing device; and
b. a software application configured to be accessed by the computing device, wherein the software application uses the data.

11. The gaming kit of claim 10, wherein the software application is configured to retrieve information from an external source.

12. The gaming kit of claim 11, wherein the external source is the Internet.

13. The gaming kit of claim 11, wherein the external source is an external storage device coupled to the computing device.

14. The gaming kit of claim 10, wherein the computing device is a mobile device.

15. A system to map physical motion data to an action within a primary application, the system comprising:
a. a motion interpretation unit; and
b. an action mapping unit, wherein the motion interpretation unit and the action mapping unit are in communication with the primary application.

16. The system of claim 15, wherein the motion interpretation unit includes:
a. a signal processor configured to encode motion data into at least one of one or more states and one or more state transitions, and to pass motion data to the action mapping unit to be directly mapped to one or more actions within the primary application; and
b. at least one finite state machine configured to interpret the motion data and to communicate with the action mapping unit a working knowledge of each of the at least one finite state machine.

17. The system of claim 15, wherein the action mapping unit includes an action dictionary configured to map at least one of one or more states and one or more state transitions to one or more input events recognized by the primary application.

18. The system of claim 15, wherein the action mapping unit is at least partly integrated with the primary application.

19. The system of claim 15, wherein the motion interpretation unit is configured to periodically sample raw motion data from one or more motion capture devices.

20. The system of claim 15, further comprising a motion sensing unit, wherein the motion sensing unit includes one or more sensors.
